(19) United States
(12) Patent Application Publication
(10) Pub. No.: US 2026/0162522 A1
(43) Pub. Date: Jun. 11, 2026

(54) SYSTEMS AND METHODS FOR DETECTING CONFIGURATION ERRORS IN A SECURITY SYSTEM

(71) Applicant: Honeywell International Inc., Charlotte, NC (US)

(72) Inventors: Asha Samaga, Bengaluru (IN); Balamurugan Ganesan, Bengaluru (IN); Vardhaman Ketappanavar, Bangalore (IN)

(21) Appl. No.: 18/975,755

(22) Filed: Dec. 10, 2024

(51) Int. Cl. G08B 29/24; G08B 29/18

(52) U.S. Cl. CPC G08B 29/24; G08B 29/185

(57) ABSTRACT

A security control panel is operatively coupled to remote support devices and includes configuration settings with at least some of the configuration settings assuming that the security control panel is operatively coupled to remote support devices of particular device types. Each remote support device stores device parameters including a device type parameter that specifies a device type of the respective remote support device. The security control panel receives the device type parameter from the remote support devices and determines when one or more of the remote support devices has an incompatible device type. When so, a configuration error is identified and the configuration error is corrected by reconfiguring the remote support devices that are identified as being incompatible with one or more of the configuration settings of the security control panel. Devices and sensors receive configuration corrections based on regulatory standard deviation analysis, ensuring compliance with regulatory requirements.

### TECHNICAL FIELD

The present disclosure relates generally to security systems, and more particularly to detecting configuration errors in a security system.

### BACKGROUND

Security systems can include a large number of components, including a large number of remote support devices that are operatively coupled with a security control panel. The security control panel and/or the remote support devices have a number of configuration settings that need to be configured when setting up a security system. The more devices that there are to configure, the chances of an error being made can increase. Configuration errors can lead to false alarms. Configuration errors can also lead to actual events not being detected, meaning possible compromises in security and safety. What would be desirable are systems and methods for detecting and resolving configuration issues in a security system.

### SUMMARY

The present disclosure relates generally to security systems, and more particularly to detecting configuration errors in a security system. An example may be found in a method for detecting configuration errors in a security system of a facility. The illustrative security system includes a security control panel that is operatively coupled to a plurality of remote support devices. The security control panel has a plurality of configuration settings with at least some of the plurality of configuration settings assuming that the security control panel is operatively coupled to one or more remote support devices of particular device types. Each of the plurality of remote support devices store one or more device parameters including a device type parameter that specifies a device type of the respective remote support device. The illustrative method includes the security control panel receiving the device type parameter from each of the plurality of remote support devices. A determination is made as to when one or more of the plurality of remote support devices has a device type that is incompatible with one or more of the plurality of configuration settings of the security control panel. When so, a configuration error in the security system is identified and the configuration error is corrected by reconfiguring one or more of the plurality of remote support devices that are identified as being incompatible with one or more of the plurality of configuration settings of the security control panel and/or reconfiguring the configuration settings of the security control panel.

Another example may be found in a security system. The illustrative security system includes a plurality of remote support devices that each has a respective device type, and a security control panel that is operatively coupled to the plurality of remote support devices. The security control panel has a plurality of configuration settings with at least some of the plurality of configuration settings assuming that the security control panel is operatively coupled to one or more remote support devices of predetermined device types. The security control panel is configured to determine when one or more of the plurality of remote support devices has a device type that is not in agreement with one or more of the plurality of configuration settings of the security control panel, and when so, identify and report a configuration error in the security system.

Another example may be found in a non-transitory computer readable medium that stores instructions. When the instructions are executed by one or more processors, the one or more processors are caused to determine when one or more of a plurality of remote support devices of a security system that are operatively coupled to a security control panel conflicts with one or more of a plurality of configuration settings of the security control panel of the security system, and when so, identify a configuration error in the security system. The one or more processors are caused to report the configuration error for correction.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic view of an illustrative security system;

FIGS. 2A and 2B are flow diagrams that together show an illustrative method for detecting configuration errors in the illustrative security system of FIG. 1;

FIG. 3 is a flow diagram that shows an illustrative method for detecting configuration errors in the illustrative security system of FIG. 1;

FIG. 4 is a flow diagram that shows an illustrative series of steps that may be carried out by one or more processors when executing stored instructions;

FIG. 5 is a flow diagram showing an illustrative method; and

FIG. 6 is a flow diagram showing an illustrative data flow.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

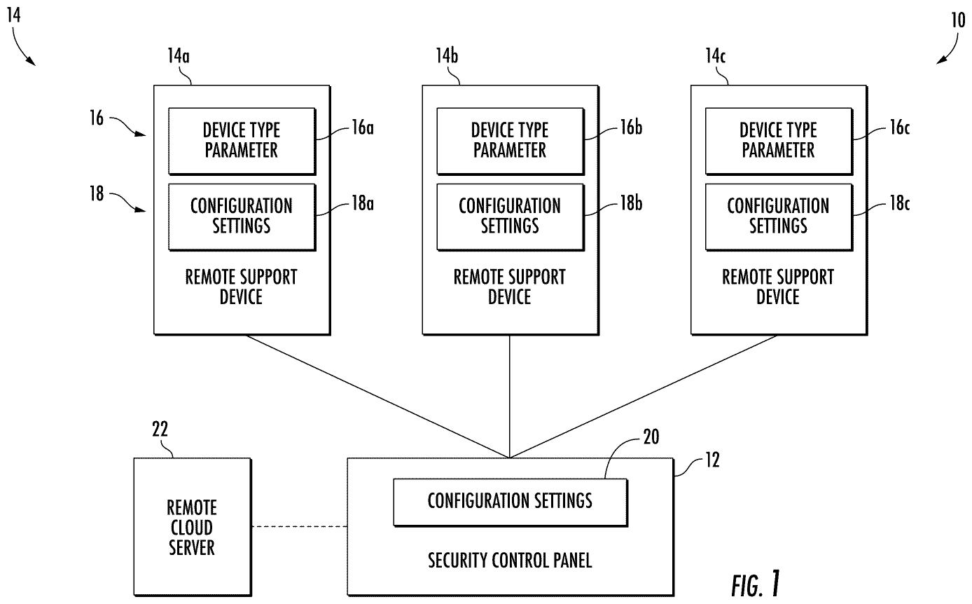

FIG. 1 is a schematic block diagram showing an illustrative security system 10. The illustrative security system 10 includes a security control panel 12 that is operatively coupled to a number of remote support devices 14, which are individually labeled as 14a, 14b and 14c. While a total of three remote support devices 14 are shown, this is merely illustrative, as the security system 10 may include any number of remote support devices 14, and in some cases may include considerably more than three remote support devices 14. In some cases, the remote support devices 14 may be security sensors. Each of the remote support devices 14 includes a device type parameter 16, individually labeled as 16a, 16b and 16c. In some cases, each of the remote support devices 14 may include configuration settings 18, individually labeled as 18a, 18b and 18c. Each of the remote support devices 14 may include additional parameters. The security control panel 12 includes configuration settings 20. At least some of the configuration settings 20 may be based on assuming that the security control panel 12 is operatively coupled to remote support devices 14 having predetermined device types and/or having predetermined configuration settings. The security control panel 12 is configured to determine when one or more of the remote support devices 14 has a device type parameter 16 and/or configuration setting that is not in agreement with one or more of the configuration settings 20 of the security control panel 12. When so, the security control panel 12 identifies and reports a configuration error in the security system 10.

In some cases, the security control panel 12 may be configured to receive the one or more configuration settings 18 of each of the remote support devices 14 that include one or more configuration settings 18. The security control panel 12 may be configured to determine when one or more of the configuration settings 18 of each of the remote support devices 14 that include one or more configuration settings 18 are not in agreement with one or more of the configuration settings 20 of the security control panel 12. When so, the security control panel 12 may be configured to identify a configuration error in the security system 10 and to correct the configuration error by reconfiguring one or more of the remote support devices 14 that are not in agreement with one or more of the configuration settings 20 of the security control panel 12.

In some cases, the security control panel 12 may be configured to receive a change to a configuration setting 18 of one of the remote support devices 14 from a user, and in response, determine whether the change to the configuration setting 18 is not in agreement with one or more of the configuration settings 20 of the security control panel 12. When so, the security control panel 12 may be configured to report a configuration error in the security system 10 to the user. In some cases, the security system 10 may further include a remote cloud server 22. In some cases, the configuration settings 20 of the security control panel 12 may include one or more encryption configuration settings that identify an encryption algorithm for communication between the security control panel 12 and the remote cloud server 22. When an installer changes one or more of the encryption configuration settings of the security control panel 12 to be incompatible with a predetermined standard, the security control panel reports a configuration error in the security system.

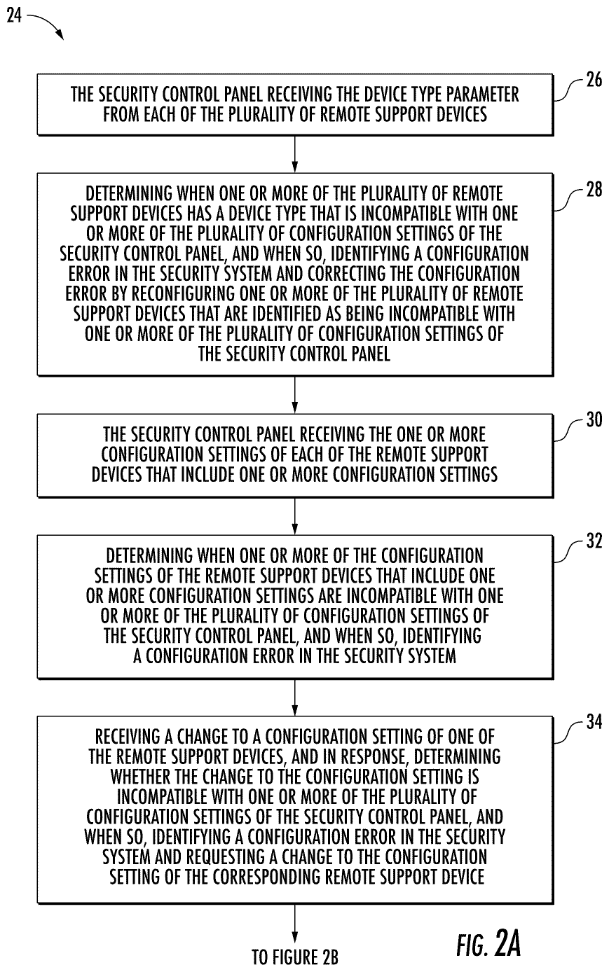

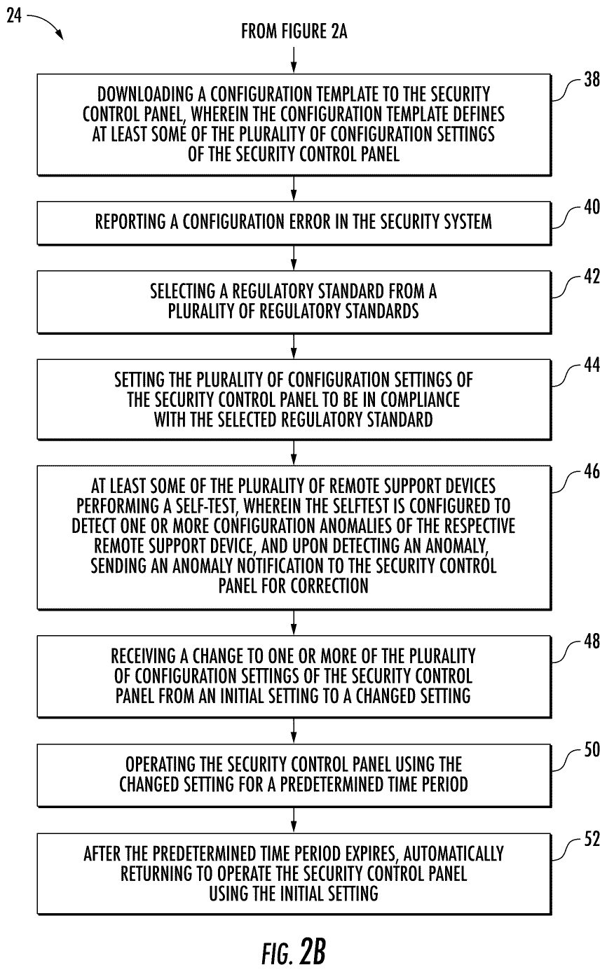

FIGS. 2A and 2B are flow diagrams that together show an illustrative method 24 for detecting configuration errors in a security system (such as the security system 10) of a facility, the illustrative security system including a security control panel (like the security control panel 12) that is operatively coupled to a plurality of remote support devices (like the remote support devices 14). In some cases, at least some of the remote support devices include one or more sensors (PIR sensor, Fire, Seismic, Glass Break, etc.) and/or one or more peripheral devices (keypad, access card reader, etc). The security control panel has a plurality of configuration settings (like the configuration settings 20) with at least some of the plurality of configuration settings assuming that the security control panel is operatively coupled to one or more remote support devices of particular device types, and each of the plurality of remote support devices store one or more device parameters including a device type parameter (like the device type parameters 16) that specifies a device type of the respective remote support device. The method 24 includes the security control panel receiving the device type parameter from each of the plurality of remote support devices, as indicated at block 36 (e.g. via a two-way communication path). A determination is made as to when one or more of the plurality of remote support devices has a device type that is incompatible with one or more of the plurality of configuration settings of the security control panel, and when so, a configuration error in the security system is identified and is corrected by reconfiguring one or more of the plurality of remote support devices that are identified as being incompatible with one or more of the plurality of configuration settings of the security control panel, as indicated at block 28. In some cases, the configuration error may be automatically corrected, while in other cases the configuration error may be reported to a technician for manual correction. In some cases, the configuration error may be a result of one or more of a technician improperly installing and/or configuring the security system during original installation and/or during subsequent maintenance of the security system, and/or may be a result of an administrator improperly reconfiguring the security system. These are just examples.

In some cases, at least some of the remote support devices may include configuration settings (like the configuration settings 18), and the method 24 may include the security control panel receiving the one or more configuration settings of each of the remote support devices that include one or more configuration settings (e.g. via a two-way communication path), as indicated at block 30. In some cases, a determination may be made as to when one or more of the configuration settings of the remote support devices that include one or more configuration settings are incompatible with one or more of the plurality of configuration settings of the security control panel, and when so, a configuration error in the security system is identified, as indicated at block 32. In some cases, the method 24 may include receiving a change to a configuration setting of one of the remote support devices and/or the security control panel, and in response, determining whether the configuration error still exists, as indicated at block 34.

Continuing on to FIG. 2B, in some cases, the method 24 may include downloading a configuration template to the security control panel, wherein the configuration template defines at least some of the plurality of configuration settings of the security control panel, as indicated at block 38. In some cases, the security control panel may be operatively coupled to a remote cloud server. The plurality of configuration settings of the security control panel may include one or more encryption configuration settings that identify an encryption algorithm for communication between the security control panel and the remote cloud server. When an installer changes one or more of the encryption configuration settings of the security control panel to be incompatible with one or more encryption configuration settings of the configuration template, the method 24 may include reporting a configuration error in the security system, as indicated at block 40.

In some cases, the method 24 may include selecting a regulatory standard from a plurality of regulatory standards, as indicated at block 42. The plurality of configuration settings of the security control panel may be set to be in compliance with the selected regulatory standard, as indicated at block 44. In some cases, the method 24 may include at least some of the plurality of remote support devices performing a self-test that is configured to detect one or more configuration anomalies of the respective remote support device, and upon detecting an anomaly, sending an anomaly notification to the security control panel for correction, as indicated at block 46. As an example, the one or more configuration anomalies may include one or more configuration settings that are incompatible with the selected regulatory standard. In some cases, the one or more configuration anomalies may include an incompatible encryption setting, an incompatible entrance delay, and incompatible exit delay, an installation of an incorrect battery type, and/or an installation of too many remote support devices on a common power supply pin of the security control panel. These are just examples.

In some cases, the method 24 may include receiving a change to one or more of the plurality of configuration settings of the security control panel from an initial setting to a changed setting, as indicated at block 48. The method 24 may include operating the security control panel using the changed configuration setting for a predetermined time period, as indicated at block 50. After the predetermined time period expires, the method 24 may include automatically returning to operate the security control panel using the initial configuration setting, as indicated at block 52.

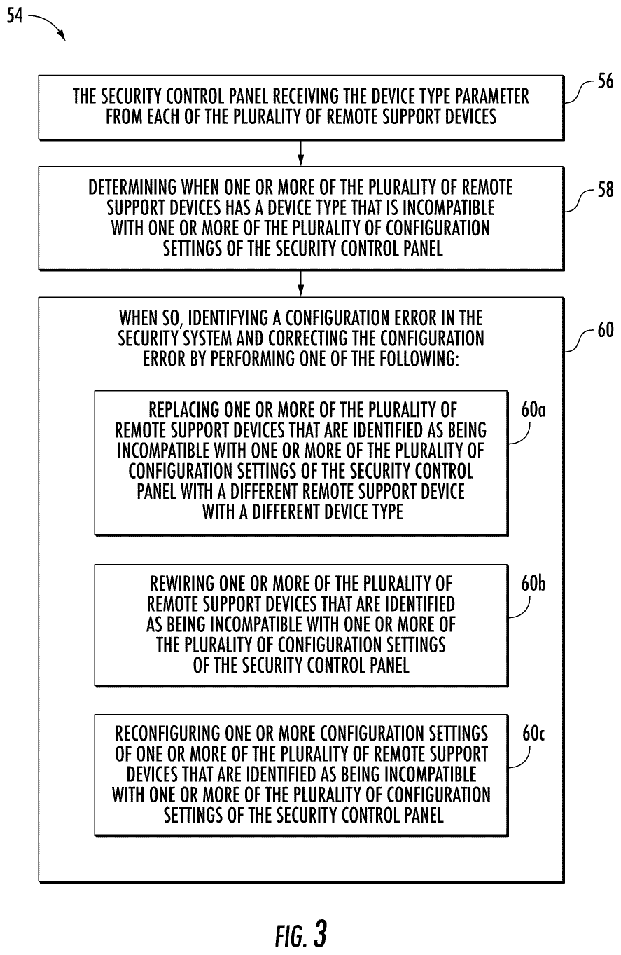

FIG. 3 is a flow diagram that shows an illustrative method 54 for detecting configuration errors in a security system (such as the security system 10) of a facility. The security system including a security control panel (like the security control panel 12) that is operatively coupled to a plurality of remote support devices (like the remote support devices 14). In some cases, at least some of the remote support devices include one or more sensors. The security control panel has a plurality of configuration settings (like the configuration settings 20) with at least some of the plurality of configuration settings assuming that the security control panel is operatively coupled to one or more remote support devices of particular device types, and each of the plurality of remote support devices store one or more device parameters including a device type parameter (like the device type parameters 16) that specifies a device type of the respective remote support device. The method 54 includes the security control panel receiving the device type parameter from each of the plurality of remote support devices (e.g. via a two-way communication path), as indicated at block 56. A determination is made as to when one or more of the plurality of remote support devices has a device type that is incompatible with one or more of the plurality of configuration settings of the security control panel, as indicated at block 58. When this occurs, a configuration error in the security system is identified and may be corrected by reconfiguring one or more of the remote support devices, as indicated at block 60. In some cases, reconfiguring one or more of the remote support device includes replacing one or more of the plurality of remote support devices that are identified as being incompatible with one or more of the plurality of configuration settings of the security control panel with a different remote support device with a different device type, as indicated at block 60a. In some cases, reconfiguring one or more of the remote support device includes rewiring one or more of the plurality of remote support devices that are identified as being incompatible with one or more of the plurality of configuration settings of the security control panel, as indicated at block 60b. In some cases, reconfiguring one or more of the remote support device includes reconfiguring one or more configuration settings of one or more of the plurality of remote support devices that are identified as being incompatible with one or more of the plurality of configuration settings of the security control panel, as indicated at block 60c. In some cases, the method includes reconfiguring one or more of the configuration settings of the security control panel.

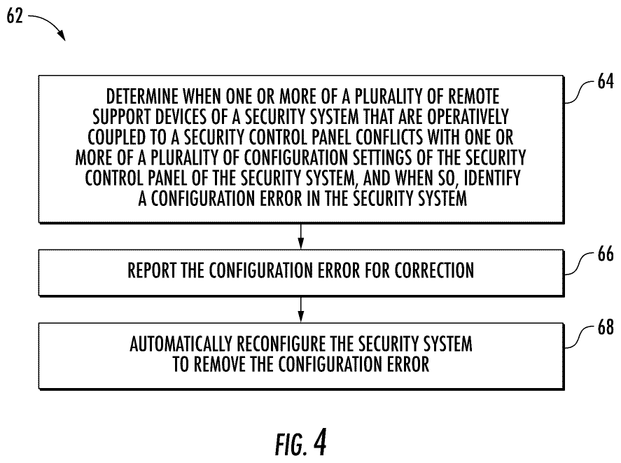

FIG. 4 is a flow diagram that shows an illustrative series of steps 62 that may be carried out by one or more processors when the one or more processors execute instructions that are stored on a non-transitory computer readable storage medium. In some cases, the one or more processors may be part of a security control panel such as the security control panel 12. The one or more processors may be caused to determine when one or more of a plurality of remote support devices of a security system that are operatively coupled to a security control panel conflicts with one or more of a plurality of configuration settings of the security control panel of the security system (e.g. via a two-way communication path with the plurality of remote support devices), and when so, identify a configuration error in the security system, as indicated at block 64. The one or more processors may be caused to report the configuration error for correction, as indicated at block 66. In some cases, the one or more processors may be caused to automatically reconfigure the security system to remove the configuration error, as indicated at block 68.

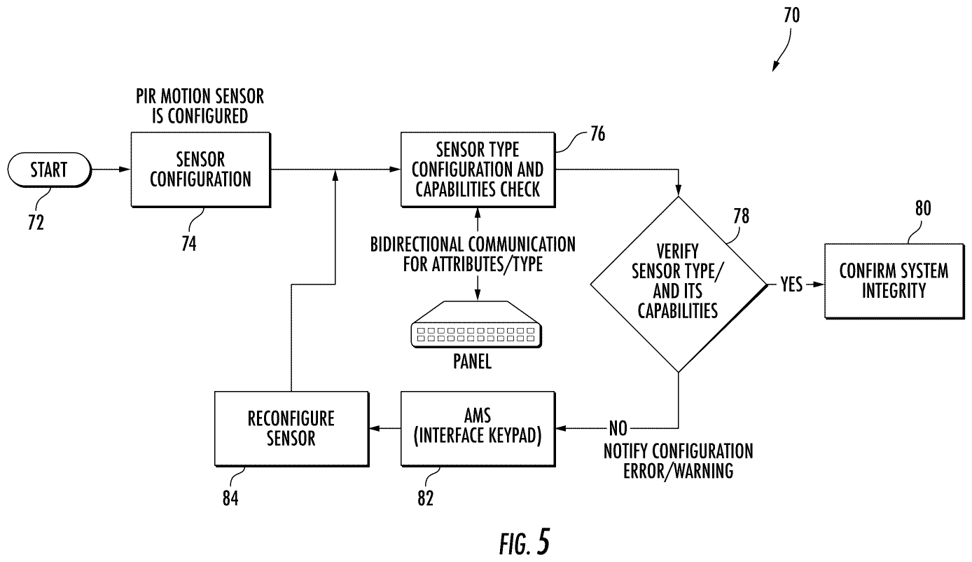

FIG. 5 is a flow diagram showing an illustrative method 70 providing an example of how two-way communication may be used. Sensors are able to share information regarding its type, configuration settings, sensed parameters and./or its capabilities back to a control panel, which has the intelligence to analyze this information. This can allow mismatches between response type and sensor configurations to be detected. In the example given in FIG. 5, a PIR motion sensor has been mistakenly configured in the control panel as an entry/exit door sensor. The method 70 begins at a start block 72. A PIR sensor is configured, as indicated at block 74. A sensor type configuration and capabilities check is performed by the control panel, as indicated at block 76. A determination is made at decision block 78 as to whether there is a match. If so, control passes to block 80, where system integrity is confirmed. If not, a configuration error or warning is issued. Control passes to block 82, where a user is able to enter updated information. The sensor is then reconfigured, as indicated at block 84. Control then reverts to block 76. The following table provides example information on sensor configuration parameters:

| Sensors | Parameters | Description |
|---|---|---|
| PIR | Mask Detection | The sensor is covered/masked by spray, paper, |
| | | tape, or film to avoid detection. EN Grade 3 system |
| | | mandates this should be enabled. |
| | Smart Contact | Sensor will send the detection state only when the |
| | | controller/area in Armed state. This will be very |
| | | useful in wireless sensors to save the battery life. |
| Fire | Low/High | Will inform the sensor sensitivity is affected due to |
| | Sensitivity | covered by dust or hardware issues need |
| | | maintenance or replacement. |
| | | UL mandates this should be enabled. |
| Seismic | External Test | The seismic sensor has the ability to support |
| | | external test by a vibration simulator to make sure |
| | | the sensor is functional. |
| | Internal Test | The seismic sensor has the ability to support |
| | | internal test by Test pulse to make sure the sensor |
| | | is functional. |
| | Sensitivity | Low/Medium/High |
| | Mode | Displacement/Acceleration/Vibration |
| Glass | Sensitivity | Low/Medium/High |
| Break | Dual Mode | To detect an alarm the flex signal must be followed |
| | | by an audio signal within a prescribed time frame. |

The following table provides example information on peripherals configuration parameters:

| Peripherals | Parameters | Description |
|---|---|---|
| | Tamper Detection | This selection will allow |
| | | the cover and wall tamper |
| | | detection of peripherals. |
| | | Some of the regulatory |
| | | standards like UL |
| | | mandates this should not |
| | | be disabled. |
| | Jamming Detection | This selection will allow |
| | | the RF Gateway peripheral |
| | | to detect the Jamming. |
| | | Some of the regulatory |
| | | standards like UL |
| | | mandates this should not |
| | | be disabled. |
| | Triple Swipe | This selection will allow |
| | | the Triple swipe on the |
| | | Access Reader connected |
| | | the Door module peripheral |
| | | to Arm the area or not. |
| | Card and PIN/only PIN | This selection will help the |
| | | Arming station to |
| | | authenticate only using the |
| | | PIN code or both PIN and |
| | | Card for users. |

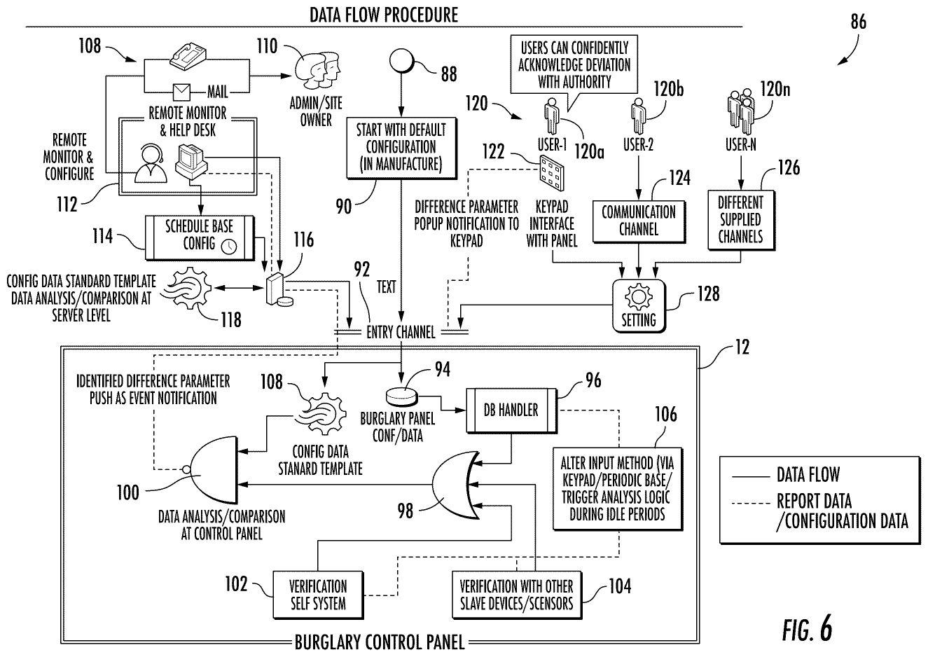

FIG. 6 is a schematic block diagram showing an illustrative data flow 86. Data flows are shown in solid line and reporting/configuration data is shown in dashed line. The data flow 86 begins at a start block 88. As indicated at block 90, a default configuration is provided to the security control panel 12 via an entry channel 92. The security control panel 12 includes a database 94 and a database handler 96. The security control panel 12 includes a logical OR gate 98 and a logical NAND gate 100. The security control panel 12 includes a self-verification system 102 and a verification for other devices 104, as well as a standard template 118. Data input 108, such as via computer, phone or mail, may be provided to an admin 110. In some cases, the data input 108 may originate in a monitor and help desk 112. The monitor and help desk 112 may output a schedule base configuration 114 to a computer 116. A standard template 118 may be in communication with the computer 116. A number of users 120, including users 120a, 120b and through 120n may provide input through a keypad interface 122, a communication channel 124 and other communication channels 124, each of which output to a settings block 128. The computer 116 and the settings block 128 each output to the security control panel 12 via the entry channel 92.

A number of scenarios may be examined looking at FIG. 6. An example is a device scheduled self-test, which enables the devices and sensors to perform self-tests without requiring human intervention or manual inspection. This can save time and resources, and can avoid possible risks. To illustrate, a scheduled service 106 runs in the security control panel 12, monitoring sensors and peripheral devices 104 for any deviations from expected operation. Upon detecting an anomaly, the control device is notified, which may involve the monitor and help desk 112, which facilities alerting the user about potential malfunctions. For example, if a 7 Ah battery is mistakenly configured as a 18 Ah battery, immediate detection of this discrepancy may be challenging. However, through scheduled checks, this issue can be identified and relayed as a notification later. Discharge speed can be added part of template based standard battery Ah.

The security control panel 12 features default settings and a standard template that are incorporated during the manufacturing process (block 90). Once installed at the user's site, it connects with peripheral support devices and requires configuration for optimal functionality. Configuration may be performed using a cloud-based GUI tool (112), which not only configures peripheral devices but also ensures crucial settings are not missing with the help of standard template (118), triggering alerts if necessary. If a device is configured externally (122, 124, 126), scheduled checks (106) verify the configurations to maintain system integrity. If any issues are detected when comparing (100) to standard template (118), it will be reported to technical support (112), and alerts will be displayed on the local keypad (122), which includes a display feature. Scheduled self-checks will be conducted to verify the status of supportive devices such as batteries, cell radios, as well as connected devices (104) like sensors and other peripherals. Tech support (112) will contact admin or the site owner (110) for deviations.

Example test scenarios may include any of the following:
1) Incorrect battery connection detected, differing from the configured battery test settings.
2) Bus Load Test: Multiple remote devices are connected to the same communication bus power supply (where exceeding power supply limit). This can be evaluated as part of the scheduled testing.
3) Configuration/Modification is performed using a third-party configuration tool 124 and 126, which does not allow feedback or deviation pop-up messages. For now, the configuration will be accepted, and deviations will be cross-checked during the scheduled testing.
4) When new templates are downloaded from the cloud server, deviations based on new values can be verified as part of the scheduled testing.

Another scenario includes a regulatory standard deviation check. In the Connected cloud, the installer can designate that the system should meet a regulatory standard like UL 2160 or EN 50131 or BS 8243. Then from the configuration data and reports across different devices and sensors of the security system, the cloud can analyze and identify the deviations from the regulatory requirements of the designated regulatory standard. For example, if a confirm alarm option is disabled in the security control panel, that is deviation BS8243. The system may provide an alert for this configuration deviation from the desired regulatory standard, which can then be corrected. Example configuration settings and/or parameters for example regulatory standards (EN 50131, BS 8243 and UL 2160 and SIA) are shown in the table below:

Table for Regulatory Requirements:

| Regulatory | | |
|---|---|---|
| Standard | Critical Parameters | Values/Range |
| EN | PIN Length | Minimum 6 digits |
| | Simple Arm/Disarm | Disabled |
| | Mobile App | Not allowed |
| | Status Display in Arm | Disabled |
| | State | |
| | Communication Path | Ethernet - 90 Seconds |
| | Supervision | Cellular - 5 Hours |
| | | DP4 system |
| | Bell Timeout | Maximum 15 minutes |
| | Prewarn Period | 15 minutes |
| | Wireless Supervision time | Minimum 120 mins |
| | Wireless activation time | Minimum 20 mins |
| | Exit Time Reset | Disabled |
| BS 8243 | Exit Delay | Infinite |
| | Bell delay | 0 seconds |
| | Abort window time | 30 seconds |
| | Burg Confirm time | Min 30 minutes |
| | | Max 60 minutes |
| | Hold up confirm time | Min 8 hours |
| | | Max 20 hours |
| | Keypad Access | Except Entry |
| | Burglary alarm restore | Disarm/unconfirmed |
| | Cross Zone | Disabled |
| | Number of confirmed | 2 |
| | alarms | |
| UL | PIN Length | Minimum 4 digits |
| | Anti Mask | Disable |
| | Bell Timeout | Minimum 16 minutes |
| | Exit Time Reset | Disabled |
| | EOLR | Enabled |
| | Entry delay | Maximum 45 seconds |
| | Exit delay | Maximum 60 seconds |
| | Tamper monitoring of | Enabled |
| | External modules | |
| | Abort window time | 0 seconds (No Delay) |
| | Cross Zone | Disabled |
| SIA | Entry Delay | Minimum 30 seconds |
| | Exit Delay | Minimum 60 seconds |
| | Swinger suppression | 1 Alarm |
| | Exit Error | Enabled |
| | Exit Time Reset | Enabled |
| | Cross Zone | Enabled with 2 zones |
| | Abort window time | Minimum 15 seconds |
| | Auto Stay | Enabled |

The system may automatically detect when the configuration settings of the security control panel and/or the remote support devices deviate from the configuration settings and/or parameters for a selected regulatory standard, and in response, may provide an alert for the deviation and/or may automatically correct the deviation.

Another scenario includes a cyber-vulnerability check. The control panel 12 communicates internally (field bus) with peripherals, and communicates with the cloud or CMS (Central monitoring station) via an entry channel 92. The communication with the cloud or CMS (Central monitoring station) may be encrypted with different methodology like TLS, TCP with encryption and so on. Any change in configuration to a non-encryption mode or to a less secure encryption mode may be flagged as a potential cybersecurity vulnerability and brought to the attention of the administrator. While selecting the CMS alarm reporting configuration setting (e.g. to report over internet) without opting for an appropriate encryption mode can pose a security risk, and as such, the system may issue an alert to the admin/user/installer and provide a suggested encryption mode. The following table provides additional encryption details:

| Configuration | Options | Default |
|---|---|---|
| Receiver Type | TLS 1.2/TCP | TLS 1.2 |
| | Encrypted/Unencrypted | |
| TCP Encrypted | AES 128/192/256 | AES 256 with CBC |
| Encryption Key mode | Fixed Key/Auto Key | Auto Key |

Note: EN 50136-2 mandates to use TLS 1.2, but if TCP Encrypted is used then need to follow AES 256 bit encryption with Auto Key mode.

Another scenario involves instant configuration validation when any configuration changes are made by an admin/user/installer. Once an admin/user/installer makes a change to any configuration setting to the security control panel and/or the remote support devices, the system may automatically perform an in-built-test for configuration setting validation and prepares a deviation list as necessary. Like sensor type, wiring mode, sensor capability deviations, and/or sensor configuration settings may be checked against the configuration settings of the control panel. In some cases, this may include checking certain electrical characteristic of the sensors. For example, if a sensor is configured to send a resistance value that is less than 1K Ohms, but the control panel expects a sensor signal that is above 1K Ohms, a discrepancy may be flagged. This way, the system can avoid false alarms caused by incompatible configurations. The device or cloud can update the template configuration accordingly or alert the user to correct the issue. Another example is a communication test with respect to cellular/LTE configuration changes validation.

Another scenario includes a template for crucial configurations and validation procedures. In this example, configurations for the cloud and devices may follow a template. The system (cloud/device) will check the configurations against the template at set times (e.g. scheduled times). If the configuration does not match, the system will show an alert to the user to correct it. The alert will keep showing until the user corrects or at least acknowledges the alert. Admin can update the template configuration to standard at any given time and changes will be tracked for auditing purposes. This will enable faster setup and prevent overlooking vital alarm report. Raising awareness to end users of configuration inconsistencies can help the end users anticipate possible malfunctions such as open circuits, faults, missed true alarms and false alarms. An example standard configuration template is shown in the table below:

### Standard Template Configuration Example:

| Features | Values | |
|---|---|---|
| Confirmation Mode | Except Entry | |
| Number of alarms | 2 | |
| Alarm Confirming Time | 30 | min |
| Entry route confirm | Enable | |
| Confirmation Mode | Disabled | |
| Number of alarms | 2 | |
| Alarm Confirming Time | 8 | h |
| Burglary Restore Options | DisARM/Restore | |
| Exit Error Logic | Leave Disarmed | |
| Exit Delay | 30 | sec |

| | |
|---|---|
| Bell Delay | 0 |
| Enable Cross Zone List | Disabled, Non |
| | configurable |
| Abort Window | 30 |
| Abort Annunciation | Enable |
| Allow reset for Confirmed Burglary | Enable |
| Alarm | |
| Allow reset for Confirmed HoldUp | Enable |
| Alarm | |
| Push to Set | Not Selected |
| Access | Except Entry |
| Alarm Reporting Limit | Unlimited |

Another scenario involves modifying and temporarily accepting a template for crucial configurations. Template modifications may be accepted by confirmation of the administrator 110. A schedule 114 may automatically revert to the original standard template after a period of time if the template modification is not confirmed and/or approved by the administrator. As an example of this situation, suppose a worker or staff member will spend a week for some assigned work in a business building. It makes sense that their movements should not be restricted in certain zones of the building for this period of time, and the configuration settings may be changed accordingly. However, there's a chance of forgetting to revert back to the previous configuration settings after the week expires. The administrator can schedule (see 114) a template modification (118, 108) after the week expires to automatically revert back to the previous configuration settings. In the above use case, a self-initiated template push can be scheduled after one week.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for detecting configuration errors in a security system of a facility, the security system including a security control panel that is operatively coupled to a plurality of remote support devices, wherein the security control panel has a plurality of configuration settings with at least some of the plurality of configuration settings assuming that the security control panel is operatively coupled to one or more remote support devices of particular device types, and wherein each of the plurality of remote support devices store one or more device parameters including a device type parameter that specifies a device type of the respective remote support device, the method comprising:
the security control panel receiving the device type parameter from each of the plurality of remote support devices; and
determining when one or more of the plurality of remote support devices has a device type that is incompatible with one or more of the plurality of configuration settings of the security control panel, and when so, identifying a configuration error in the security system and correcting the configuration error by reconfiguring one or more of the plurality of remote support devices that are identified as being incompatible with one or more of the plurality of configuration settings of the security control panel.

2. The method of claim 1, wherein the plurality of remote support devices comprise one or more sensors.

3. The method of claim 1, wherein at least some of the plurality of remote support devices comprise one or more configuration settings, the method comprising:
the security control panel receiving the one or more configuration settings of each of the remote support devices that include one or more configuration settings; and
determining when one or more of the configuration settings of the remote support devices that include one or more configuration settings are incompatible with one or more of the plurality of configuration settings of the security control panel, and when so, identifying a configuration error in the security system.

4. The method of claim 3, comprising:
receiving a change to a configuration setting of one of the remote support devices, and in response, determining whether the change to the configuration setting is incompatible with one or more of the plurality of configuration settings of the security control panel, and when so, identifying a configuration error in the security system and requesting a change to the configuration setting of the corresponding remote support device.

5. The method of claim 1, wherein one or more of the plurality of remote support devices store one or more configuration settings, the method comprising:
determining when one or more configuration settings of one or more of the plurality of remote support devices is incompatible with one or more of the plurality of configuration settings of the security control panel, and when so, reconfiguring the one or more configuration settings of the one or more of the plurality of remote support devices to be compatible with the one or more of the plurality of configuration settings of the security control panel.

6. The method of claim 1, further comprising downloading a configuration template to the security control panel, wherein the configuration template defines at least some of the plurality of configuration settings of the security control panel.

7. The method of claim 6, wherein the security control panel is operatively coupled to a remote cloud server, and wherein the plurality of configuration settings of the security control panel include one or more encryption configuration settings that identify an encryption algorithm for communication between the security control panel and the remote cloud server, wherein when an installer changes one or more of the encryption configuration settings of the security control panel to be incompatible with one or more encryption configuration settings of the configuration template, reporting a configuration error in the security system.

8. The method of claim 1, further comprising:
selecting a regulatory standard from a plurality of regulatory standards; and
setting the plurality of configuration settings of the security control panel to be in compliance with the selected regulatory standard.

9. The method of claim 1, further comprising:
at least some of the plurality of remote support devices performing a self-test, wherein the self-test is configured to detect one or more configuration anomalies of the respective remote support device, and upon detecting an anomaly, sending an anomaly notification to the security control panel for correction.

10. The method of claim 9, wherein the one or more configuration anomalies comprise one or more of:
an installation of an incorrect battery in the respective remote support device; and
an installation of too many remote support devices on a common power supply.

11. The method of claim 1 comprising:
receiving a change to one or more of the plurality of configuration settings of the security control panel from an initial setting to a changed setting;
operating the security control panel using the changed setting for a predetermined time period; and
after the predetermined time period expires, automatically returning to operate the security control panel using the initial setting.

12. The method of claim 11, wherein receiving the change to one or more of the plurality of configuration settings of the security control panel includes receiving a duration of the predetermined time period.

13. The method of claim 1, wherein reconfiguring one or more of the plurality of remote support devices that are identified as being incompatible with one or more of the plurality of configuration settings of the security control panel comprises one or more of:
replacing one or more of the plurality of remote support devices that are identified as being incompatible with one or more of the plurality of configuration settings of the security control panel with a different remote support device with a different device type;
rewiring one or more of the plurality of remote support devices that are identified as being incompatible with one or more of the plurality of configuration settings of the security control panel; and
reconfiguring one or more configuration settings of one or more of the plurality of remote support devices that are identified as being incompatible with one or more of the plurality of configuration settings of the security control panel.

14. The method of claim 1, wherein the configuration error is a result of one or more of:
an installer improperly configuring the security system during original installation and/or subsequent maintenance of the security system; and
an administrator improperly reconfiguring the security system.

15. A security system comprising:
a plurality of remote support devices, wherein each of the plurality of remote support devices has a respective device type;
a security control panel operatively coupled to the plurality of remote support devices, wherein the security control panel has a plurality of configuration settings with at least some of the plurality of configuration settings assuming that the security control panel is operatively coupled to one or more remote support devices of predetermined device types; and
the security control panel configured to determine when one or more of the plurality of remote support devices has a device type that is not in agreement with one or more of the plurality of configuration settings of the security control panel, and when so, identify and report a configuration error in the security system.

16. The security system of claim 15, wherein at least some of the plurality of remote support devices comprise one or more configuration settings, the security control panel configured to:
receive the one or more configuration settings of each of the remote support devices that include one or more configuration settings; and
determine when one or more of the configuration settings of each of the remote support devices that include one or more configuration settings are not in agreement with one or more of the plurality of configuration settings of the security control panel, and when so, identify a configuration error in the security system and correcting the configuration error by reconfiguring one or more of the plurality of remote support devices that are not in agreement with one or more of the plurality of configuration settings of the security control panel.

17. The security system of claim 16, wherein the security control panel is configured to receive a change to a configuration setting of one of the remote support devices from a user, and in response, determine whether the change to the configuration setting is not in agreement with one or more of the plurality of configuration settings of the security control panel, and when so, report a configuration error in the security system to the user.

18. The security system of claim 15 further comprising a remote cloud server, and wherein the plurality of configuration settings of the security control panel include one or more encryption configuration settings that identify an encryption algorithm for communication between the security control panel and the remote cloud server, wherein when an installer changes one or more of the encryption configuration settings of the security control panel to be incompatible with a predetermined standard, reporting a configuration error in the security system.

19. A non-transitory computer readable medium storing instructions that when executed by one or more processors causes the one or more processors to:
determine when one or more of a plurality of remote support devices of a security system that are operatively coupled to a security control panel conflicts with one or more of a plurality of configuration settings of the security control panel of the security system, and when so, identify a configuration error in the security system; and
report the configuration error for correction.

20. The non-transitory computer readable medium of claim 19, wherein the instructions cause the one or more processors to automatically reconfigure the security system to remove the configuration error.
